(19) United States
(12) Patent Application Publication
(10) Pub. No.: US 2009/0237385 A1
(43) Pub. Date: Sep. 24, 2009

(54) Display Apparatus and Power Control Circuit thereof

(76) Inventors: Yung-Liang LEE, Hsin-Chu (TW); Shun-Tien Huang, Hsin-Chu (TW)

Correspondence Address: Portal IPR Office;Chun-Ming Shih, P.O. box 223205, Chantilly, VA, 20153, US

(21) Appl. No.: 12/370,772

(22) Filed: Feb. 13, 2009

(30) Foreign Application Priority Data
Mar. 19, 2008 (TW) 097109718

(51) Int. Cl. G09G 5/00

(52) U.S. Cl. 345/211

(57) ABSTRACT

In a display apparatus and a power control circuit thereof, the power control circuit includes an image signal input terminal, a resistor-capacitor (RC) filter and a switch. The image signal input terminal is configured for receiving an image signal and providing a waiting-for-processing signal corresponding to the image signal. The RC filter is configured for receiving the waiting-for-processing signal and filtering out an alternating-current (AC) component of the waiting-for-processing signal to generate a switch control signal. The switch is electrically connected between a power supply and an electronic element, and configured for receiving the switch control signal and making the switch control signal control on-off state of the switch.

### CROSS-REFERENCE TO RELATED APPLICATIONS

This application is based upon and claims the benefit of priority from the prior Taiwanese Patent Application No. 097109718, filed Mar. 19, 2008, the entire contents of which are incorporated herein by reference.

### BACKGROUND

1. Field of the Invention

The disclosed embodiments of the present invention relate to a display apparatus and a power control circuit thereof, and more specifically to a display apparatus and a power control circuit thereof, which does not use a microprocessor to detect the state of the display apparatus and the power control circuit thereof, and may automatically save power consumption of the display apparatus and the power control circuit thereof if no signal is inputted.

2. Description of the Related Art

Display apparatus is an information-providing device widely used by people. The display apparatus is configured for providing various patterns and characters to transmit the information more conveniently. However, with the development of the modern society, it is more and more important to save power. The information-providing device is also needed to save power. At present, the display apparatus may be divided into two types with the saving-power mode, one type is automatically entering into the saving-power mode after not using the display apparatus for a predetermined time; and the other is automatically entering into the saving-power mode if no signal inputting.

Referring to FIG. 1, a typical power control circuit of a display apparatus is provided. Generally, the typical power control circuit 10 employs a switch 120 for controlling whether power supplied from a power supply 130 is transmitted to an electronic element 140. The switch 120 is controlled (turned on/off) according to a micro-process unit 110 detecting image signals. An image signal source 100 is used as an input terminal of the display apparatus to be configured for receiving the image signals. The image signals received from the image signal source 100 are transmitted to the micro-process unit 110 to perform essential processing programs. The essential processing programs including a determination program are configured for determining whether image signals have been inputted, to control the on-off state of the switch 120.

The switch 120 is controlled by the micro-process unit 110 to determine whether the power is supplied to the electronic element 140, such that the typical power control circuit 10 may save much more power. However, the micro-process unit 110 may operate incessantly and consume the power, such that the typical power control circuit 10 has a limit for saving the power. That is, even if the display apparatus enters into the saving-power mode, the power supply 130 also may supply the power to the micro-process unit 110. If not, the micro-process unit 110 may not induce the display apparatus to enter into a normal mode from a saving-power mode. Therefore, the typical power control circuit 10 has the limit for saving the power.

What is needed is to provide a power control circuit, which may solve the above problems.

### BRIEF SUMMARY

A display apparatus in accordance with one embodiment of the present invention is provided. The display apparatus may induce the display apparatus to enter into a normal mode from a saving-power mode without supplying power to a micro-process unit.

A power control circuit of a display apparatus in accordance with an exemplary embodiment of the present invention is provided. The power control circuit may automatically determine whether power supplied from the power supply is transmitted to an electronic element of the display apparatus without using the micro-process unit. The power control circuit includes an image signal input terminal, a resistor-capacitor (RC) filter and a switch. The image signal input terminal is configured for receiving an image signal and providing a waiting-for-processing signal corresponding to the image signal. The RC filter is configured for receiving the waiting-for-processing signal and filtering out an alternating-current (AC) component of the waiting-for-processing signal to generate a switch control signal. The switch is electrically connected between the power supply and the electronic element, and configured for receiving the switch control signal, and the switch control signal is configured for controlling on-off state of the switch.

A display apparatus in accordance with another exemplary embodiment of the present invention is provided. The display apparatus includes a power supply, an electronic element, a switch, a first image signal input terminal and a first RC filter. The power supply is configured for supplying power needed by the display apparatus. The switch is electrically connected between the power supply and the electronic element. The first image signal input terminal is configured for receiving a first image signal and providing a first waiting-for-processing signal corresponding to the first image signal. The first RC filter is electrically connected to the first image signal input terminal and configured for filtering out an AC component of the first waiting-for-processing signal to generate a first switch control signal for controlling on-off state of the switch.

The embodiments of the present invention employ the RC filter to achieve some specific signals (such as horizontal synchronous signal, vertical synchronous signal, or digital differential signal) from the image signals, and employ the specific signals to directly control the on-off state of the switch. Thus the embodiments of the present invention may easily control the output of the power without using the micro-process unit.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit block diagram of a conventional power control circuit of a display apparatus.

FIG. 2 is a circuit block diagram of a display apparatus, in accordance with an exemplary embodiment of the present invention.

FIG. 3A is a circuit block diagram of an RC filter in accordance with an exemplary embodiment of the present invention.

FIG. 3B is a circuit diagram of the RC filter in accordance with an exemplary embodiment of the present invention.

FIG. 3C is a circuit diagram of a switch signal generator in accordance with an exemplary embodiment of the present invention.

FIG. 4A is a circuit block diagram of an image signal input terminal in accordance with another exemplary embodiment of the present invention.

FIG. 4B is a circuit diagram of a filter amplifier in accordance with an exemplary embodiment of the present invention.

FIG. 5 is a circuit block diagram of a display apparatus in accordance with an exemplary embodiment of the present invention.

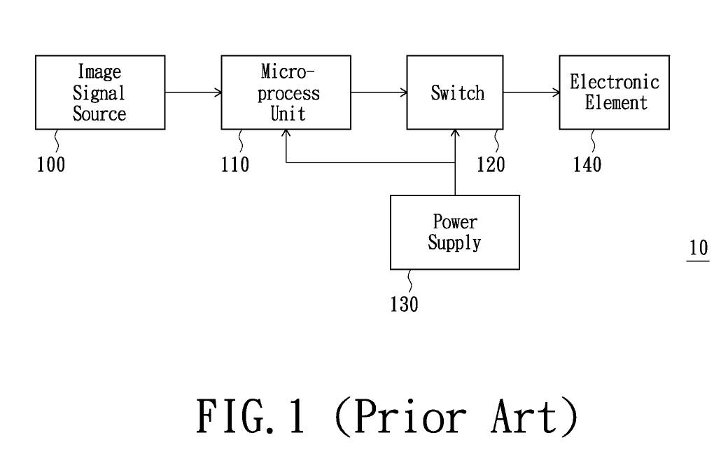

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings

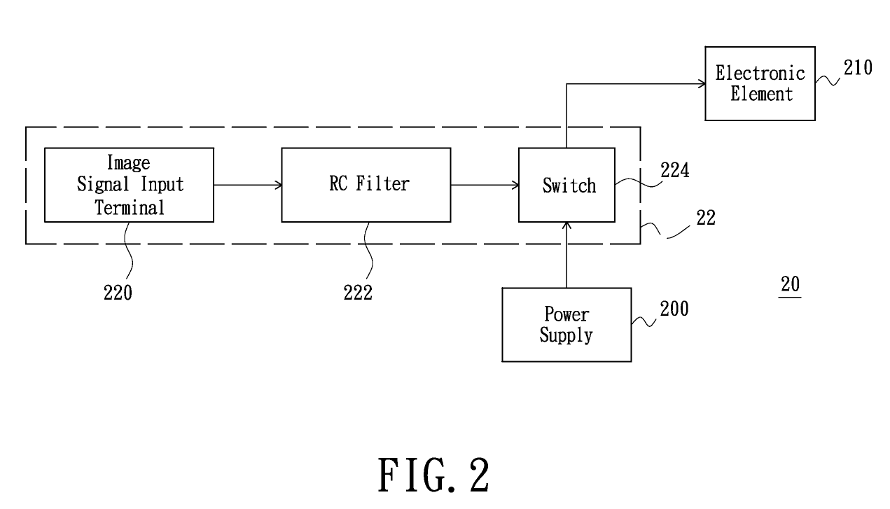

Referring to FIG. 2, a circuit block diagram of a display apparatus, in accordance with an exemplary embodiment, is provided. In this exemplary embodiment, the display apparatus 20 includes a power supply 200, an electronic element 210 and a power control circuit 22. The power control circuit 22 includes an image signal input terminal 220, an RC (resistor-capacitor) filter 222 and a switch 224. The power control circuit 22 is electrically connected between the power supply 200 and the electronic element 210 to control whether power supplied from the power supply 200 is transmitted to the electronic element 210. More concretely, the image signal input terminal 220 receives an image signal from an image providing device (for example, a computer), and then transmits the image signal or a derived signal derived from the image signal (defined as a waiting-for-processing signal in following), to the RC filter 222. The RC filter 222 receives the waiting-for-processing signal from the image signal input terminal 220, and filters an AC (alternating-current) component of the waiting-for-processing signal to generate a switch control signal. The switch control signal is transmitted to the switch 224 for controlling on-off state thereof. The switch 224 is electrically connected between the power supply 200 and the electronic element 210, and is controlled by the switch control signal to determine whether the power supplied from the power supply 200 is transmitted to the electronic element 210.

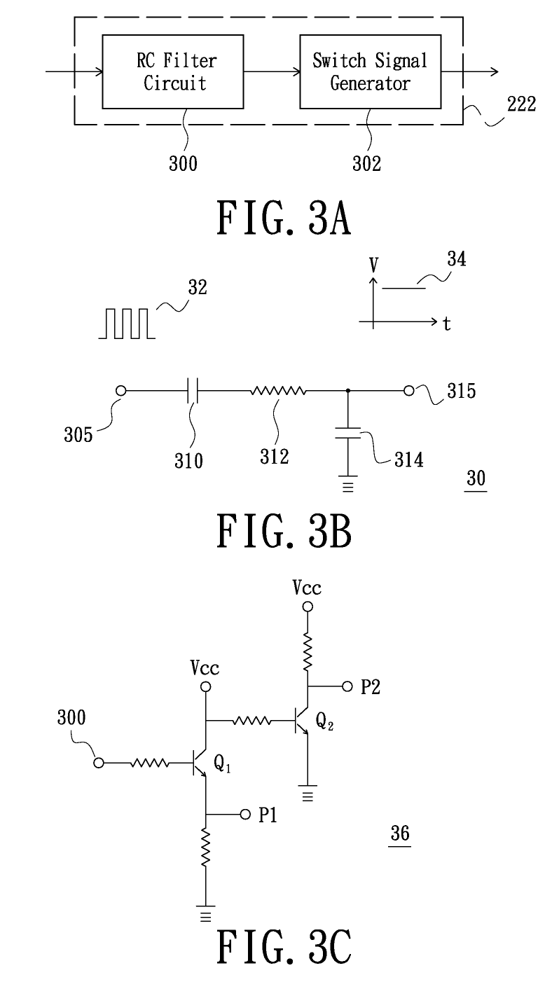

Referring to FIG. 3A, a circuit block diagram of the RC filter, is shown. In this exemplary embodiment, the RC filter 222 includes a RC filter circuit 300 and a switch signal generator 302. The RC filter circuit 300 is configured for filtering the AC component of the waiting-for-processing signal to generate a tiny switch control signal. The tiny switch control signal is then transmitted into the switch signal generator 302, and the switch signal generator 302 generates the switch control signal transmitted to the switch 224 as shown in FIG. 2, according to the tiny switch control signal.

Referring to FIG. 3B, a circuit diagram of an RC filter circuit, is shown. In this exemplary embodiment, the RC filter circuit 30 includes two capacitors 310 and 314, and a resistor 312. One terminal of the capacitor 310 is electrically connected to an input terminal 305, and another terminal thereof is electrically connected to one terminal of the resistor 312. Another terminal of the resistor 312 is electrically connected to an output terminal 315 and one terminal of the capacitor 314. Another terminal of the capacitor 314 is electrically connected to the ground. The RC filter circuit 30 receives the waiting-for-processing signal 32 via the input terminal 305, and the waiting-for-processing signal 32 is filtered to get rid of the AC component thereof when passing through the capacitors 310, 314 and the resistor 312, such that the tiny switch control signal 34 is generated at the output terminal. It should be noted that, if the waiting-for-processing signal 32 is an input signal as shown in FIG. 3B, the tiny switch control signal 34 may be kept at a level substantially though it may be a tiny up-and-down wave. Relatively, if the waiting-for-processing signal 32 is kept at the low logic level (that is, no image signal being inputted), the tiny switch control signal 34 is also kept at the low logic level. The logic level of the tiny control signal 34 is controlled by adjusting the values of the capacitors 310, 314 and the resistor 312. It should be obvious for persons skilled in the art to adjust the values of the capacitors and the resistor.

Referring to FIG. 3C, a circuit diagram of the switch signal generator, is shown. In this exemplary embodiment, the input terminal of the switch signal generator 36 is electrically connected to the RC filter circuit 300 for receiving the tiny switch control signal sent therefrom. The tiny switch control signal is configured for changing the potential of an output node P1. If the tiny switch control signal has an enough potential to turn on a transistor Q1, the potential of the output node P1 is close to the level of a power supply Vcc. Contrarily, if the potential of the tiny switch control signal is low and cannot turn on the transistor Q1, the potential of the output node P1 is the ground potential. Furthermore, since a transistor Q2 is turned on constantly, the potential of an output node P2 is very close to the ground potential. Thus, the switch control signal sent from the switch signal generator 36, is generated by comparing the potentials of the output nodes P1 and P2. In this exemplary embodiment, the two output nodes P1 and P2 are designed since some circuits are turned on in the high logic level and some circuits are turned on in the low logic level. Therefore, the present switch signal generator 36 is suited for various circuits. The output node P2 may be electrically connected to the circuits turned on in the low logic level; and the output node P1 may be electrically connected to the circuits turned on in the high logic level. It should be noted that, if the circuit electrically connected to the present switch signal generator 36 is predetermined, the present switch signal generator 36 may only include one of the output nodes P1 and P2.

The image signal input terminal 220 as shown in FIG. 2 is discussed in the following for various image signals. It is well known that, the image signals may be divided into analog image signals and digital image signals. If the inputted image signals are the analog image signals, the image signal input terminal 220 as shown in FIG. 2 is a pure input node. However, if the inputted image signals are the digital image signals, for example, the signals of the DVI (digital visual interface) standard or the signals of the HDMI (high-definition multimedia interface) standard, a corresponding circuit may be employed to process the signals.

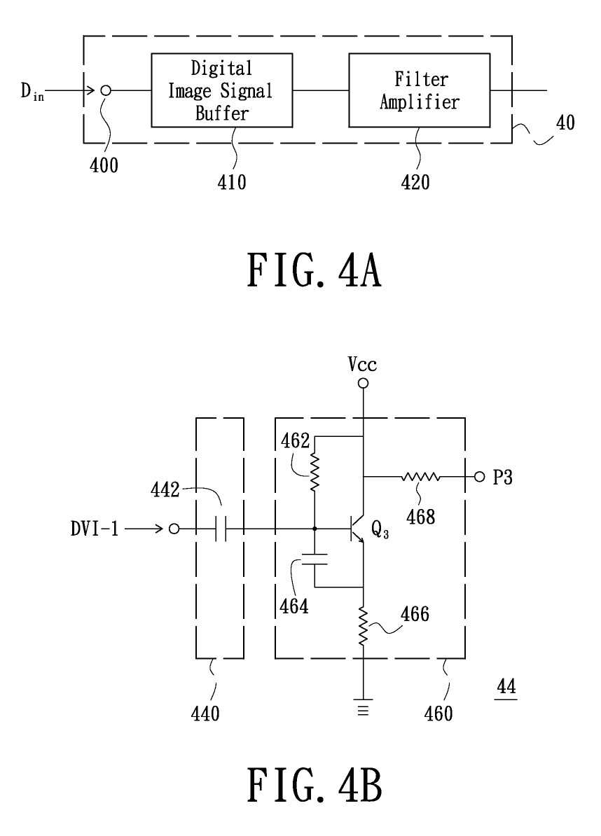

Referring to FIG. 4A, an interior circuit block diagram of the image signal input terminal, in accordance with another exemplary embodiment, is shown. In this exemplary embodiment, the image signal input terminal 40 is suited for processing the digital image signals. The image signal input terminal 40 includes a digital image signal input terminal 400, a digital image signal buffer 410 and a filter amplifier 420. The digital image signal input terminal 400 receives a digital image signal Din from the image providing device (for example, the computer), and transmits the digital image signal Din to the digital image signal buffer 410. The digital image signal buffer 410 then transmits the digital image signal Din to the filter amplifier 420 and the micro-process unit (not shown) via two output paths, respectively. The digital image signal buffer 410 provides the digital image signal DVI-1 to the filter amplifier 420, and the filter amplifier 420 is configured for filtering out an DC (direct-current) component of the digital image signal DVI-1 (generally being the DC carrier wave of the digital image signal Din) and amplifying a temporary storage data generated from filtering out the DC component of the digital image signal DVI-1 to generate the waiting-for-processing signal provided to the RC filter 222 as shown in FIG. 2.

The digital image signal buffer 410 is an common electronic element in the market, for example, a product of EP9122 (HDMI Buffer(splitter)) type manufactured by the Explore Microelectronics Inc. Referring to FIG. 4B, a circuit diagram of the filter amplifier, in accordance with an exemplary embodiment, is shown. In this exemplary embodiment, the filter amplifier 44 includes a digital image signal capacitor filter circuit 440 and an amplifier 460. The digital image signal capacitor filter circuit 440 may be a capacitor 442. One terminal of the capacitor 442 is configured for receiving the digital image signal DVI-1 (defined as the temporary storage signal DVI-1 in the following) provided to the filter amplifier 44 from the digital image signal buffer 410. Another terminal thereof is electrically connected to the gate terminal of a transistor Q3 of the amplifier 460. The temporary storage signal DVI-1 is inputted into the digital image signal capacitor filter circuit 440 and then filtered out the DC component by the capacitor 442. A result (defined as the DC filtering-out signal in the following) generated from filtering out the DC component of the temporary storage signal DVI-1 is transmitted to the amplifier 460.

In this exemplary embodiment, the amplifier 460 includes the transistor Q3, resistors 462, 466 and 468, and a capacitor 464. The DC filtering-out signal is provided to the gate terminal of the transistor Q3 to control on-off state thereof. The DC filtering-out signal is amplified by the amplifier 460, and then sent out from an output node P3 to be the waiting-for-processing signal sent from the image signal output terminal 40.

It should be noted that, since the current digital image signal usually employs a group differential signals to transmit the data, and the change of the potentials of the group differential signals is little, the DC filtering-out component should be amplified for performing following processes. If the standard of the digital image signal is changed, the circuit as shown in FIG. 4B should be changed correspondingly. The circuit of the present invention is not limited in FIG. 4B.

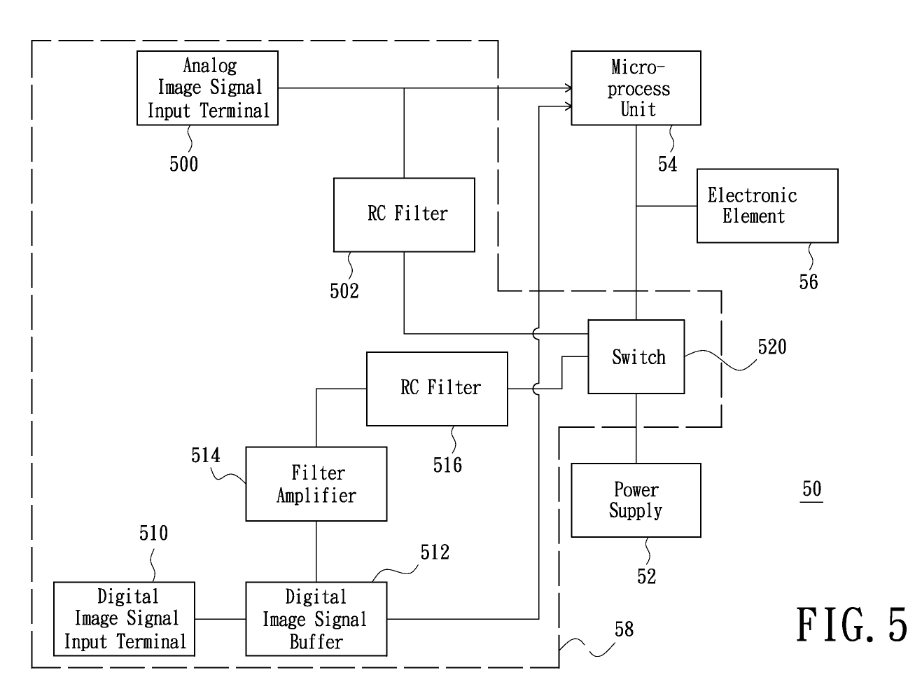

Referring to FIG. 5, a circuit block diagram of a display apparatus, in accordance with an exemplary embodiment, is provided. In this exemplary embodiment, the display apparatus 50 includes a power supply 52, a micro-process unit 54, an electronic element 56 and a power control circuit 58. The power supplied from the power supply 52 is controlled by the power control circuit 58 to determine whether being transmitted to the micro-process unit 54 and the electronic element 56. The power control circuit 58 includes an analog image signal input terminal 500 and an RC filter 502; a digital image signal input terminal 510, a digital image signal buffer 512, a filter amplifier 514 and a RC filter 516 related to the inputting and detecting of the digital image signal; and a switch 520. The operating mode and corresponding circuit of any element has been described in FIG. 2 to FIG. 4B, respectively. The switch control signal (defined as the first switch control signal in the following) sent from the RC filter 502 and/or the switch control signal (defined as the second switch control signal in the following) are used to control the on-off state of the switch 520. Generally, the switch 520 may be a MOS (metal-oxide semiconductor) transistor. Of course, the switch 520 may be an other-type switch.

Once the first switch control signal and/or the second switch control signal represent that the analog image signal or the digital image signal is inputted into the display apparatus 50, the switch 520 is turned on, and the power is supplied from the power supply 520 to the micro-process unit 54 and the electronic element 56 for processing the analog image signal (defined as the first image signal) received from the analog image signal input terminal 500 and/or the digital image signal (defined as the second image signal) received from the digital image signal input terminal 510. In this condition, the electronic element 56 is normally operated because of supplying the power. Contrarily, if the first switch control signal and the second switch control signal both represent that no image signal is inputted into the display apparatus 50, the switch 520 is turned off, and the display apparatus 50 may enter into the saving-power mode to decrease the power consumptions.

From the above, the embodiments of the present invention employ a logic circuit to detect the inputted image signal, thus it may determine easily whether the power supplied from the power supply is transmitted to the whole display apparatus without using the micro-process unit. Thus, the power of the display apparatus may be controlled easily, and the display apparatus may further save the power without using the micro-process unit in the saving-power mode. The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power control circuit of a display apparatus, configured for controlling the electronic approach between an electronic element of the display apparatus and a power supply, comprising:
an image signal input terminal configured for receiving an image signal and providing a waiting-for-processing signal corresponding to the image signal;
a resistor-capacitor filter configured for receiving the waiting-for-processing signal and filtering out an alternating-current component of the waiting-for-processing signal to generate a switch control signal; and
a switch electrically connected between the power supply and the electronic element, and configured for receiving the switch control signal, and the switch control signal configured for controlling on-off state of the switch.

2. The power control circuit of the display apparatus as claimed in claim 1, wherein the image signal input terminal comprises an analog image signal input terminal configured for receiving the image signal comprising an analog image signal.

3. The power control circuit of the display apparatus as claimed in claim 2, wherein the resistor-capacitor filter comprises:
a resistor-capacitor filter circuit configured for filtering out the alternating-current component of the waiting-for-processing signal to generate a tiny switch control signal; and
a switch signal generator configured for generating the switch control signal according to the tiny switch control signal.

4. The power control circuit of the display apparatus as claimed in claim 1, wherein the image signal input terminal comprises:
a digital image signal input terminal configured for receiving the image signal comprising a digital image signal;
a digital image signal buffer configured for receiving and outputting the digital image signal; and
a filter amplifier configured for receiving the digital image signal, filtering out a direct-current component of the digital image signal, and amplifying a result generated from filtering out the direct-current component of the digital image signal to generate the waiting-for-processing signal.

5. The power control circuit of the display apparatus as claimed in claim 4, wherein the resistor-capacitor filter comprises:
a resistor-capacitor filter circuit configured for filtering out the alternating-current component of the waiting-for-processing signal to generate a tiny switch control signal; and
a switch signal generator configured for generating the switch control signal according to the tiny switch control signal.

6. The power control circuit of the display apparatus as claimed in claim 4, wherein the filter amplifier comprises:
a digital image signal capacitor filter circuit configured for receiving the digital image signal and filtering out the direct-current component of the digital image signal to generate a direct current filtering-out signal; and
an amplifier configured for amplifying the direct current filtering-out signal to generate the waiting-for-processing signal.

7. A display apparatus, comprising:
a power supply configured for supplying power needed by the display apparatus;
an electronic element configured for consuming the power supplied from the power supply;
a first image signal input terminal configured for receiving a first image signal and providing a first waiting-for-processing signal corresponding to the first image signal;
a first resistor-capacitor filter configured for receiving the first waiting-for-processing signal and filtering out an alternating-current component of the first waiting-for-processing signal to generate a first switch control signal; and
a switch electrically connected between the power supply and the electronic element, and configured for receiving the first switch control signal, and the first switch control signal configured for controlling on-off state of the switch.

8. The display apparatus as claimed in claim 7, further comprising:
a micro-process unit electrically connected to the first image signal input terminal and the switch, the micro-process unit being configured for receiving the first image signal from the first image signal input terminal and processing the first image signal by the power transmitted from the power supply when the switch is turned on.

9. The display apparatus as claimed in claim 7, wherein the first image signal received by the first image signal input terminal comprises an analog image signal.

10. The display apparatus as claimed in claim 9, wherein the first resistor-capacitor filter comprises:
a first resistor-capacitor filter circuit configured for filtering out the alternating-current component of the first waiting-for-processing signal to generate a first tiny switch control signal; and
a first switch signal generator configured for generating the first switch control signal according to the first tiny switch control signal.

11. The display apparatus as claimed in claim 10, further comprising:
a digital image signal input terminal configured for receiving a second image signal comprising a digital image signal and outputting the digital image signal;
a digital image signal buffer electrically connected to the digital image signal input terminal and configured for receiving and outputting the digital image signal;
a filter amplifier electrically connected to the digital image signal buffer, and configured for receiving the digital image signal, filtering out a direct-current component of the digital image signal and amplifying a result generated from filtering out the direct-current component of the digital image signal to generate a second waiting-for-processing signal; and
a second resistor-capacitor filter electrically connected to the filter amplifier and configured for filtering out the alternating-current component of the second waiting-for-processing signal to generate a second switch control signal for controlling the on-off state of the switch.

12. The display apparatus as claimed in claim 11, wherein the second resistor-capacitor filter comprises:
a second resistor-capacitor filter circuit configured for filtering out the alternating-current component of the second waiting-for-processing signal to generate a second tiny switch control signal; and
a second switch signal generator configured for generating the second switch control signal according to the second tiny switch control signal.

13. The display apparatus as claimed in claim 11, wherein the filter amplifier comprises:
a digital image signal capacitor filter circuit configured for receiving the digital image signal, filtering out the direct-current component of the digital image signal to generate a direct current filtering-out signal; and
an amplifier configured for amplifying the direct current filtering-out signal to generate the second waiting-for-processing signal.

14. The display apparatus as claimed in claim 11, further comprising:
a micro-process unit electrically connected to the first image signal input terminal, the digital image signal buffer and the switch, the micro-process unit being configured for receiving the first image signal from the first image signal input terminal, receiving the digital image signal from the digital image signal buffer, and processing at least one of the first image signal and the digital image signal by the power transmitted from the power supply when the switch is turned on.

15. The display apparatus as claimed in claim 7, wherein the first image signal input terminal comprises:
a digital image signal input terminal configured for receiving a digital image signal;
a digital image signal buffer configured for receiving and outputting the digital image signal; and
a filter amplifier electrically connected to the digital image signal buffer and configured for receiving the digital image signal, filtering out a direct-current component of the digital image signal, and amplifying a result generated from filtering out the direct-current component of the digital image signal to generate the first waiting-for-processing signal.

16. The display apparatus as claimed in claim 15, wherein the first resistor-capacitor filter comprises:
a resistor-capacitor filter circuit configured for filtering out the alternating-current component of the first waiting-for-processing signal to generate a tiny switch control signal; and
a switch signal generator configured for generating the first switch control signal according to the tiny switch control signal.

17. The display apparatus as claimed in claim 15, wherein the filter amplifier comprises:
a digital image signal capacitor filter circuit configured for receiving the digital image signal, and filtering out the direct-current component of the digital image signal to generate a direct current filtering-out signal; and
an amplifier configured for amplifying the direct current filtering-out signal to generate the first waiting-for-processing signal.

18. The display apparatus as claimed in claim 15, further comprising:
a micro-process unit electrically connected to the first image signal input terminal and the switch, the micro-process unit being configured for receiving the first image signal from the first image signal input terminal and processing the first image signal by the power transmitted from the power supply when the switch is turned on.
